(19) United States
(12) Patent Application Publication
(10) Pub. No.: US 2026/0264018 A1
(43) Pub. Date: Sep. 10, 2026

(54) Acoustic separation of CO2 from the atmosphere

(71) Applicant: Warren Lynn Cooley, Salem, OR (US)

(72) Inventor: Warren Lynn Cooley, Salem, OR (US)

(21) Appl. No.: 18/831,507

(22) Filed: Mar. 10, 2025

(51) Int. Cl. B01D 57/00

(52) U.S. Cl. CPC B01D 57/00; B01D 2221/16; B01D 2257/504

(57) ABSTRACT

a means for clearing the atmosphere of CO2 molecules by: First, changing the molecule to one of two IR active modes, where it becomes a dipole, thereby reactive to a magnetic fields. Second, by facilitating a unquie frequency of rotation or tagging the CO2 molecule with a certain frequency. Third, and finally by using the momentum in an acoustic wave at the same certain frequency to sweep CO2 out of the source stream for collection.

### BACKGROUND PRIOR ART

The following is a tabulation of some of the prior art that appears relevant:
US Patent Application 60/890,190 Warren L Cooley Filed Feb. 16, 2007 Abandoned
U.S. Pat. No. 4,945,693 Aug. 7, 1990 Inventor: Warren L. Cooley
U.S. Pat. No. 5,214,921 June 1,1993 Inventor: Warren L. Cooley
U.S. Pat. No. 5,325,642 Jul. 5,1994 Inventor Warren L. Cooley
U.S. Pat. No. 5,192,450 Filed Mar. 9, 1993 Joseph S. Heyman Assignee: US Government

### BACKGROUND: A DISCUSSION OF THE PRIOR ART

Scientific data and consensus have emerged increasing percentages of CO2 in the atmosphere contributes to warming the earth. It is little wonder that this would be the case CO2 is known to absorb inf rad radiation. This warming is popularly referred to as the “greenhouse effect”. And it is dangerous to humans. Heat kills, first water and storms and then crops and food. Humans even under the best conditions cannot live in sustained temperatures above 126 degrees F. We can not perspire fast enough to cool ourselves and we cook to our demise.

Once emitted into the atmosphere CO2 is rapidly distributed in the atmosphere, upper oceans and vegetation. Subsequently, the carbon cycle continues into soils, the deeper oceans and rocks. These exchanges take much longer. Between 15% and 40% of CO 2 will remain in the atmosphere for up to 2000 years. There are significant difference between human time scales and geological time scales, hence to accumulation of CO2 is the atmosphere. For humans the consumption of hydrocarbon fuels has an unfortunate downside. We emit CO2 in its IR inactive state and it absorbs inf rad radiation from millions of decentralized locations daily. This has been occurring for more then 100 years.

Unfortunately, this trend is accelerating in 2023 humanity set the record for total consumption of hydrocarbons. A distinction we nay come to regret. It is becoming clear that humans need alternatives to hydrocarbons. But little if anything has been done in this pursuit.

There are just two basic approaches toward reducing emissions of CO2. They are machines that capture CO2 from flue gases and machines that are designed for direct air capture. Both feature membrane filters that need cleaning and sometimes replacement raising the cost of sequestration and threatening an effort to protect our environment. To date, humanity has not proven very responsive to the global warming problem, perhaps that will change as the crisis grows? There is ; little distinction between these two approaches towards reducing CO2 in the atmosphere. But much discussion is taking place among the community of scientists about the correct approach. Where should the emphasis be placed? The reality of the global carbon cycle speaks to the need for both approaches.

Recently, science has moved to serious talk of the need for geo-engineering. This is dangerous without total reversibility in the solution. Our climate crisis is evolving slowly. It relies on a solution and is handicapped by our current political polarization.

One is reminded that humans are tough, resourceful and we think. These are useful allies in this fight for an earth, we can live on.

### SUMMARY

The only embodiment presented here is a machine to separate CO2 from the atmosphere. It democratizes the process of cleaning the atmosphere, making it available to all building owners.

### ADVANTAGES

Several advantages of the machine to separate CO2 from the atmosphere are articulated as follows. It is an all electric systems as such it benefits from an ease of maintenance. It also finds benefit in the ease with which new parts can be acquired. It can be easily installed in the duct-work of a force air system and can benefit from the actions of existing fans. A network for sales, installation, and maintenance already exists. This network can be very helpful in getting newer products to the marketplace.

### DRAWINGS & FIGURES

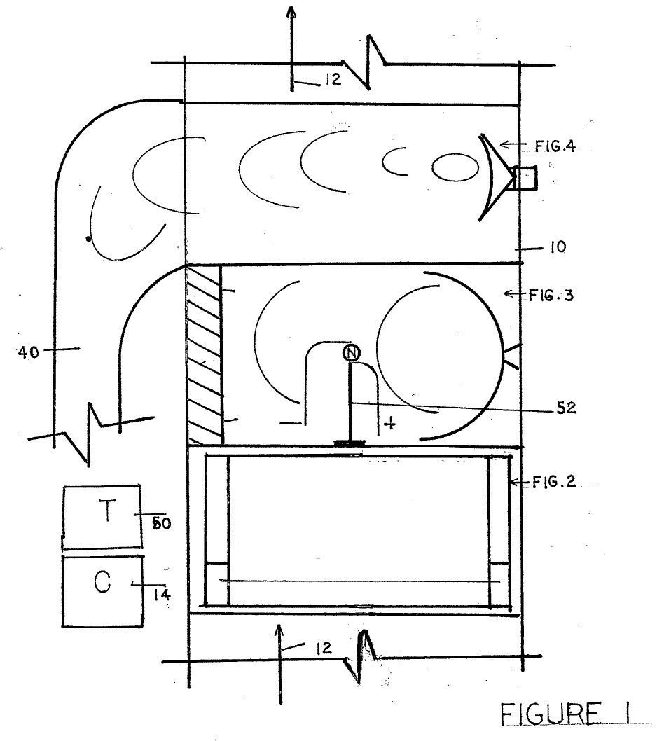

FIG. 1 Horizontal Assembly—Right side view
10—Surrounding duct
12—Air stream in and out perpendicular to action of the machine.
14—Control
50—Tuner
52—Stand

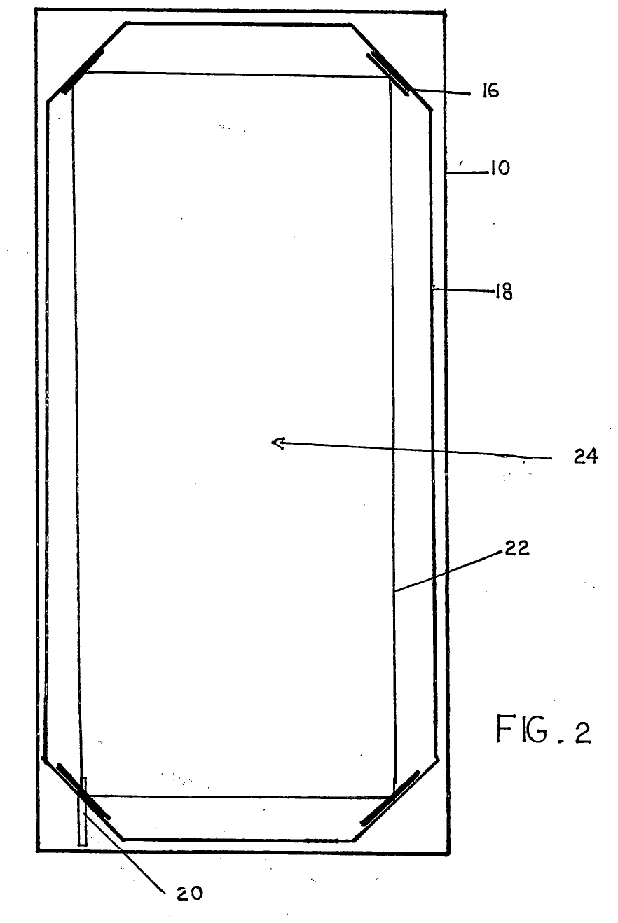

FIG. 2 Mirrors—plan view
10—Surrounding duct
16—(4) Mirrors nominal sizes 1′×1′
18—1″ Hardboard insulation with aluminum reflective face on sides and ends.
20—Laser apparatus
22—Laser beam
24—Photon field

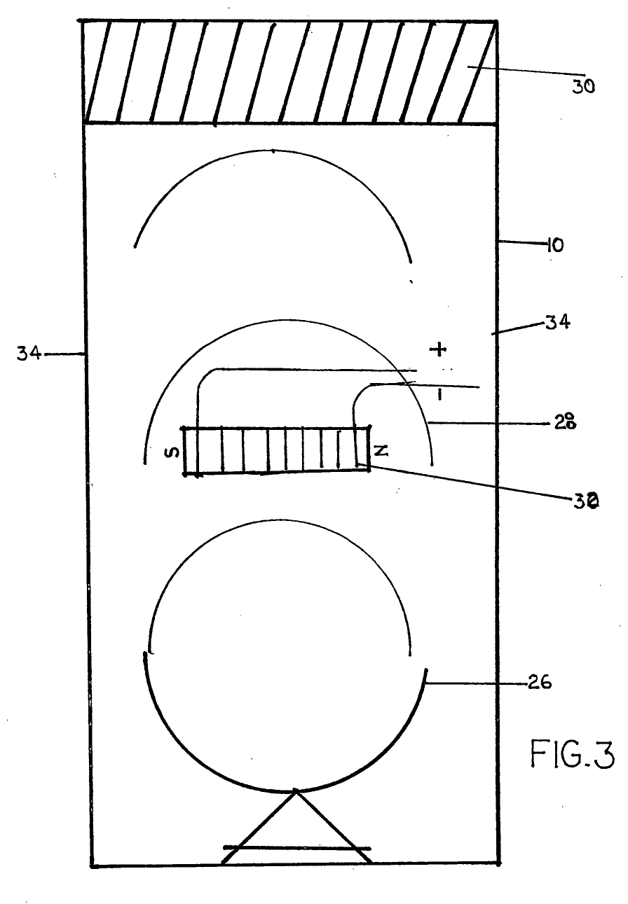

FIG. 3 RF and Magnet—plan view
10—Surrounding duct
26—RF antenna
28—RF wave
30—RF wave absorber
32—Electromagnet
34—Non-reflective sides/RF absorber (two sides and one end)

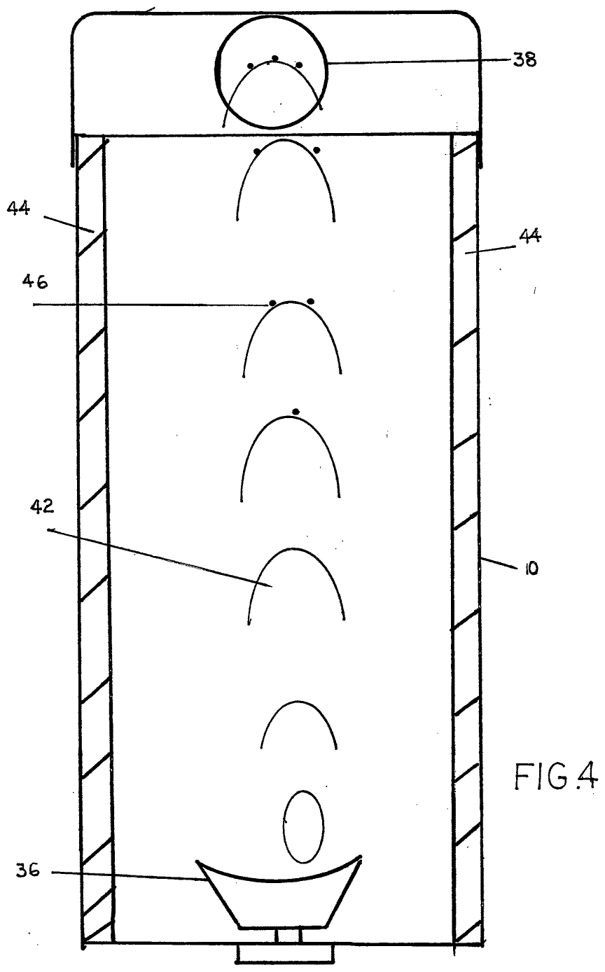

FIG. 4 The Sweep—plan view
10—Surrounding duct.
36—Transducer
38—Separation Port
40—Separation Conduit
42—Acoustic wave
44—Acoustic absorber
46—CO2 Molecule

### DESCRIPTION OF THE INVENTION

The operation is controlled 14 by a short series of time clocks functioning together. They stag the operation of the machine (FIG. 1). In most installations this control is connected to the HVAC system. Specifically when the HVAC fan engages. Access to the controller 14 opens and the machine (FIG. 1) can engage and remove CO2 molecules. [symbol] CO2 molecule to rotate at a frequency. Adjustments can be made to three variables: charge, velocity and the magnetic field to slow the motion and tune the CO2 molecules rotation to be accessible to acoustic interaction. All CO2 molecules passing this stage (FIG. 3) will have identical rotational profiles.

Perpendicular to the aforementioned air stream a transducer 36 (FIG. 4) is positioned to one side of the flow. Opposite and approximately parallel and on the other side of the source stream is a separation port 38. The transducer 36 is suitably tuned to produce the same frequencies as rotating molecules and acoustic waves. This frequency carries the CO2 molecules towards the separation port 38 and then to conduit 40 where the molecules are sequestered. The air stream continues but without CO2 molecules. There are two items on the drawings that have not been mentioned. In (FIG. 1) 50 is identified as a tuner a one time appliance used to set up the magnet 32, the RF antenna 26 and the acoustic transducer 36 in (FIG. 1). The stand 52 supports the magnet shown in (FIG. 1).

### Operation of the Invention

The invention can be installed in a section of duct preferably horizontally and can be easily and quickly sized for the circumstance from plans or inspection. It is most easily installed as part of a new system, but of course, can be retrofitted to most older HVAC systems. In either case, new or a retrofit, the existing HVAC fan may need adjustment.

In the first of three stages (FIG. 2) the CO2 molecule is transformed into a dipole by tera hertz radiation at a specific frequency and becomes reactive to magnetic fields. During this first stage (FIG. 2) the incoming air (atmosphere) contains CO2 molecules that are in an IR inactive mode. They are transformed into IR active molecules of CO2 and become dipoles, hence reactive to magnetic fields and manipulatable. The space made reference to in (FIG. 2) is essentially a mirrored box open on the top and bottom to the air stream moving through it.

In the second stage (FIG. 3) of the process, energy is added or coupled to the CO2 molecules to facilitate it's identity among other molecules comprising the atmosphere. This coupling allows for

[symbol]

This embodiment utilizes the existing air flow created by existing fan(s) generally inherent in HVAC systems. (Existing fan(s) may need to be supplemented.)

In the only embodiment of the invention presented (FIG. 1) here the apparatus is suitable for installation in any HVAC duct system with access to the general atmosphere, from which the molecule CO2 must be separated.

The apparatus (FIG. 1) is fitted perpendicular to the flow of the source stream. It is perhaps best located in the duct, on the return air side and up stream of the return air vent. The three components should be installed horizontally so that the order of operation moves through each section (FIGS. 2, 3 and 4) in order. It is anticipated that a source stream of air moves freely from one end of the apparatus to the other.

The apparatus (FIG. 1) includes power capable of producing radiation in the terra hertz range (between 20.01 and 70.42 Tera Hertz) These are the frequencies of the two IR active modes of CO 2. The laser (FIG. 2) has been developed and can now produce radiation in the TeraHertz range. The CO2 molecule has several modes in the most common mode it oscillates at 41.61 tera hertz (IR inactive mode). As mentioned CO2 vibrates in several modes two are IR active, meaning when they occur they express themselves as dipoles. The most common mode of CO2 is IR inactive, and is subject to absorbing inf rad radiation. It comprises less then 4% of the earth's atmosphere.

Once the molecule CO2 becomes a dipole by shifting it self to either the asymmetrical (preferred) or the bend mode. It can be manipulated with a magnetic field. This is the crux of the invention. Stimulate an IR active mode of CO2, then use magnetic to identify the molecule and acoustics to separate CO2 from the molecules comprising the atmosphere.

Having completed exposure to a laser 20 which produced the correct molecular frequency. The airstream moves to the next stage (FIG. 3). Here you find an RF antenna 26 with the arrangement of an electromagnet 32 perpendicular to the field transmission of the RF antenna 26. This causes the rotation at specific frequency, hence identification

In the third and final stage (FIG. 4) of the process removes CO2 molecules from an air stream to the exclusion of other molecules in the air stream. In a real sense, two streams of gas are created one is atmosphere or air without CO2 molecules the other is CO2 gas. In the third stage (FIG. 4) an acoustic transducer 36 is set perpendicular to the air stream and at a frequency which interacts only with the rotational frequency of the CO2 molecules. The transducer 36 is producing acoustic waves 44 at the same frequency as the CO2 molecule rotates through one cycle.

The acoustic momentum moves CO2 molecules out of the air stream and into the separation port 38.

### Additional Embodiments

The inventor has not included other embodiments of the invention. New configurations might arise? But, confidence in the three step process for clearing the atmosphere of CO2 is high.

### Conclusions, Ramifications and Scope

Accordingly, a new technology, perhaps a bit out in front of dramatic need but aimed at responding to one of humanities biggest problems, global warming. We humans are pushing on the environment we live in, in a variety of ways, some of them are harmful, mostly in the longer term, but . . . it get's shorter.

None the less, there will come a time? If you are poor, it may have already, come?

It happens slowly at first, but, in poorer places in the world, you can see evidence, hotter during hot days, then water issues. It would be handy to know? How far we are from the strong survive, right next too only the strong survive and so on? Things begin to breakdown, dependability is gone, society changes.

So, an invention thought about and developed with the hope that it might solve a problem we have yet to fully recognize, global warming. Sparking others, perhaps?, to think about things, differently. So, that what we (society) need is there when we need it.

I have great hope for this invention. It is simple and speaks to an issue society is beginning to recognize, global warming. I admit it is difficult to hear with all the noise, politics and such, but I see it all, as a distraction. Things in the atmosphere effect us all, and humans don't do well in the heat.

As to the ramifications, as one reads through the patent, one quickly comes to the conclusion that there is only one embodiment included. This is on purpose for one reason: I am hoping for as much innovation as possible. and wide spread use. It would be wonderful if there were versions or different sizes and even adaptive versions of this machine in every building. Perhaps in time, people will not buy a furnace unless it includes a CO2 removal process and equipment.

The principle advantage of using this invention is a cleaner atmosphere for everyone and perhaps, a halt to the phenomena of “global warming”.

1. A method for removing CO2 molecules 46 from an atmospheric air stream comprising:
a. using a laser beam and exciting the CO2 molecule with a frequency in the tera hertz range, thereby making the CO2 molecules responsive to a magnetic field,
b. magnetically, identifying or “tagging” CO2 molecules with a frequency of rotation, they become identifiable, among the many other molecules in an atmospheric air stream,
c. produced by a transducer fixed perpendicular to said air stream, the momentum from an acousticwave at this same frequency, is used to sweep the air stream clear of CO2 molecule.

2. A machine for clearing an atmospheric air stream of CO2 molecules 46, comprising:
a. a means for producing a field of terahertz radiation, from a laser or other complimentary device, thereby moving the CO2 molecules from an IR inactive state to an IR active state, they become dipoles, reactive to a magnetic field,
b. a magnetic field for adjusting the rotation frequency of the CO2 molecules,
c. a perpendicularly fixed transducer for producing acoustic waves of energy, in a frequency with rotating CO2 molecules and capable of pushing the CO2 molecules out of the perpendicular air stream, for collection.

3. A method for transforming the molecule CO2 (IR inactive) into an (IR active) mode by means of exposure to terahertz radiation. When the molecule CO2 is in an IR active state. It can be made to rotate at a specific frequency in a magnetic field. By an acoustic wave that is transmitted perpendicular to the air stream, at the same frequency as the CO2 molecules rotate, the CO2 molecules are sweep by the momentum of the acoustic wave out of the air stream to the exclusion of other molecules in the air stream, CO2 molecules can be collected via a separation port and conduit for disposal or further use.
a. create a field of terahertz radiation surrounding a perpendicularly flowing air stream and transforming CO2 molecules in said air stream from IR inactive to an IR active CO2 molecules, thereby making them responsive to magnetics,
b. use a magnetic field to give a specific frequency of rotation to CO2 molecules, thereby identifying them among the many other molecules in the air stream,
c. use an acoustic wave at the same frequency as CO2 molecules to sweep by means of acoustic momentum the CO2 molecules out the air stream for collection via separation port and separation conduit.

4. Clear the atmosphere of excess CO2 molecules comprisng:
a. create a field of terahertz radiation surrounding and perpendicularly flowing air stream and transforming CO2 molecules in said airstream from IR inactive to IR active CO2 molecules, thereby making them respond to magnetic fields,
b. use the magnetic field to give a specific frequency to the CO2 molecules, thereby identifying them amoung the many other molecules in the air stream,
c. use an acoustic wave at the same frequency as the CO2 molecules to sweep the CO2 molecules out of the air stream for collection via separation port.

5. A method of removing CO2 molecules from the atmosphere comprising:
a. using a laser to excite the CO2 molecule with a frequency in the terahertz range, thereby producing a dipole, that is responsive to magnetic fields,
b. use a magnetic field to give CO2 a unique frequency of rotation,
c. use acoustic wave momentum and energy at the frequency of the rotating CO2 molecules to sweep CO2 molecules into a separation port, completing the process.

6. A machine for clearing the air of CO2 molecules 46 comprising:
a. a means for producing a field of terahertz radiation at the correct frequency, thereby transforming the molecules
b. a means for producing a magnetic field to give CO2 molecules a specific frequency of rotation
c. a perpendicularly fixed transducer for producing acoustic waves in frequency with the CO2 molecules and exclusively pushing the molecules into a separation port and finally into separation conduit for disposal or further use.
